(19) United States
(12) Patent Application Publication
(10) Pub. No.: US 2003/0036927 A1
(43) Pub. Date: Feb. 20, 2003

(54) Healthcare information search system and user interface

(76) Inventor: Susan W. Bowen, Broomall, PA (US)

Correspondence Address: Siemens Corporation, Intellectual Property Department, 186 Wood Avenue South, Iselin, NJ, 08830, US

(21) Appl. No.: 10/219,547

(22) Filed: Aug. 15, 2002

Related U.S. Application Data
(60) Provisional application No. 60/313,662, filed on Aug. 20, 2001.

(51) Int. Cl. G06F 7/00; G06F 17/30; G06F 17/60; G06F 17/00

(52) U.S. Cl. 705/4; 707/104.1; 707/3

(57) ABSTRACT

A record explorer for a healthcare information system includes a user interface and a search engine. The user interface includes an input device and an output device. The input device is adapted to receive search criteria related to a patient record. The output device is adapted to provide search results responsive to receiving the search criteria. The search engine is adapted to perform a search responsive to receiving the search criteria to generate search results.

### CROSS-REFERENCE TO RELATED APPLICATIONS

The present application is a non-provisional application of provisional application having serial number 60/313,662 filed by Susan W. Bowen on Aug. 20, 2001.

### FIELD OF THE INVENTION

The present invention generally relates to healthcare information systems. More particularly, the present invention relates to a record explorer, including a user interface and search engine, for a healthcare information system and method therefor.

### BACKGROUND OF THE INVENTION

Modern healthcare requires the concurrent provision of services by many health-care workers to many patients. In order to accomplish this, healthcare delivery has been organized into specialized departments such as, for example, nursing, laboratory, pharmacy and radiology departments. Each department has responsibility for accomplishing its particular, often specialized, subset of tasks. Unfortunately, this has resulted in fragmented patient care and sub-optimal healthcare operations. A single healthcare process, such as the ordering and administration of a medication, sometimes requires the participation of multiple health-care workers that may be associated with multiple departments resulting in increased opportunities for error and delay.

Clinical and healthcare information systems have been computerized to help health-care workers perform individual tasks. However, most systems typically have limited capability to manage a sequence of the individual tasks involved in healthcare processes. This is particularly true when the processes require the involvement of one or more health-care workers associated with one or more departments.

Some computerized systems include workflow management systems that are designed to manage complex processes, called workflows, which include multiple individual work steps, forming a sequence and schedule of tasks, performed by one or more workers associated with one or more departments. These systems permit customized configuration of the workflows, as well as continuous monitoring and management while the workflows are in progress. Preferably, these systems support configuration of the workflows at a local level where the workers implement the workflows.

Some computerized systems also have a user interface permitting workers to input information, such as via a keyboard or a touch screen, and receive output information, such via a display or recorded format on paper or a recording medium, related to the workflows. Workers use the user interface to perform tasks such as, for example, searching and reporting results, ordering goods and services, documenting clinical and nursing care, and capturing financial or operational data.

Most of the computerized systems store a large amount of information, including the workflows, department information and each patient's medical record, for example. In order to perform their tasks, workers need to access specific information among the great amount of information. Typically, workers manually access one or more separate electronic files, each containing many individual electronic files or documents, one at a time to find the file or document having the specific information, which is very time consuming. Workers that do not know or remember which file contains the specific information spend even more time searching for the specific information. Hence, these types of computerized systems fail to provide the flexible and comprehensive user interfaces and search engines needed to support adequate searching of clinical and health-care information that involve one or more health-care workers associated with one or more departments.

A desirable computerized clinical and health-care system would have a user interface and a search engine that permit users to search across multiple categories of search criteria, that permit users to search criteria that combine selections under the multiple categories of search criteria, and that automatically conveniently opens and displays several potentially applicable documents for review and edit. Such a user interface and a search engine would permit users to create their own search criteria to find specific information quickly and to view or update the specific information, as appropriate. Accordingly, there is a need for a record explorer, including a user interface and search engine, for a healthcare information system and method therefor.

### SUMMARY OF THE INVENTION

A record explorer for a healthcare information system includes a user interface and a search engine. The user interface includes an input device and an output device. The input device is adapted to receive search criteria related to a patient record. The output device is adapted to provide search results responsive to receiving the search criteria. The search engine is adapted to perform a search responsive to receiving the search criteria to generate search results.

These and other aspects of the present invention are further described with reference to the following detailed description and the accompanying figures, wherein the same reference numbers are assigned to the same features or elements illustrated in different figures. Note that the figures may not be drawn to scale. Further, there may be other embodiments of the present invention explicitly or implicitly described in the specification that are not specifically illustrated in the figures and visa versa.

### BRIEF DESCRIPTION OF THE DRAWINGS

FIG. 1 illustrates a healthcare information system including a record explorer, in accordance with a preferred embodiment of the present invention.

FIG. 2 illustrates a method performed by the record explorer, as shown in FIG. 1, for searching a patient record, in accordance with the preferred embodiment of the present invention.

FIG. 3 illustrates a display of a user interface with a documents tab selected for the healthcare information system, as shown in FIG. 1, in accordance with the preferred embodiment of the present invention.

FIG. 4 illustrates a list of files under the documents tab, as shown in FIG. 3, in accordance with the preferred embodiment of the present invention.

FIG. 5 illustrates a document selected under one of the files, as shown in FIG. 4, in accordance with the preferred embodiment of the present invention.

FIG. 6 illustrates the display of the user interface with a contacts tab selected for the healthcare information system, as shown in FIG. 1, in accordance with the preferred embodiment of the present invention.

FIG. 7 illustrates the display of the user interface with an organization tab selected for the healthcare information system, as shown in FIG. 1, in accordance with a preferred embodiment of the present invention.

FIG. 8 illustrates a document selected and opened responsive to search criteria selected under the documents tab, as shown in FIG. 3, the contacts tab, as shown in FIG. 4, and the organization tab, as shown in FIG. 7., in accordance with the preferred embodiment of the present invention.

FIG. 9 illustrates the document, as shown in FIG. 1, being updated, in accordance with the preferred embodiment of the present invention.

FIG. 10 illustrates another example of a document that may be selected and opened responsive to search criteria selected under the documents tab, as shown in FIG. 3, the contacts tab, as shown in FIG. 4, and the organization tab, as shown in FIG. 7., in accordance with the preferred embodiment of the present invention.

### DETAILED DESCRIPTION OF THE PREFERRED EMBODIMENTS

Generally, a user accesses a record explorer, having a user interface and a search engine, from a clinical desktop of a client device. The user selects a patient on which to perform a search. The record explorer presents a series of search criteria on separate tabs with sub-elements for the user to select and build criteria for the search related to the patient's record. For example, the user may select from a list of document types, visits, problems, content definitions, care plans, and healthcare organization as a basis for the search. As the user selects the items for the search, a criteria statement is created and displayed so users can see selected search criteria. Alternatively, the user may use just the contents tab and perform a keyword search to find explanations for clinical terms. After the user initiates the search, the record explorer displays the search results as a list of documents or objects that meet the search criteria. The user selects those items the user wants to view. The user can select each item separately or in a filtered view where all selections are listed at one. If the user has the appropriate privileges, the user may view or update the documents or objects.

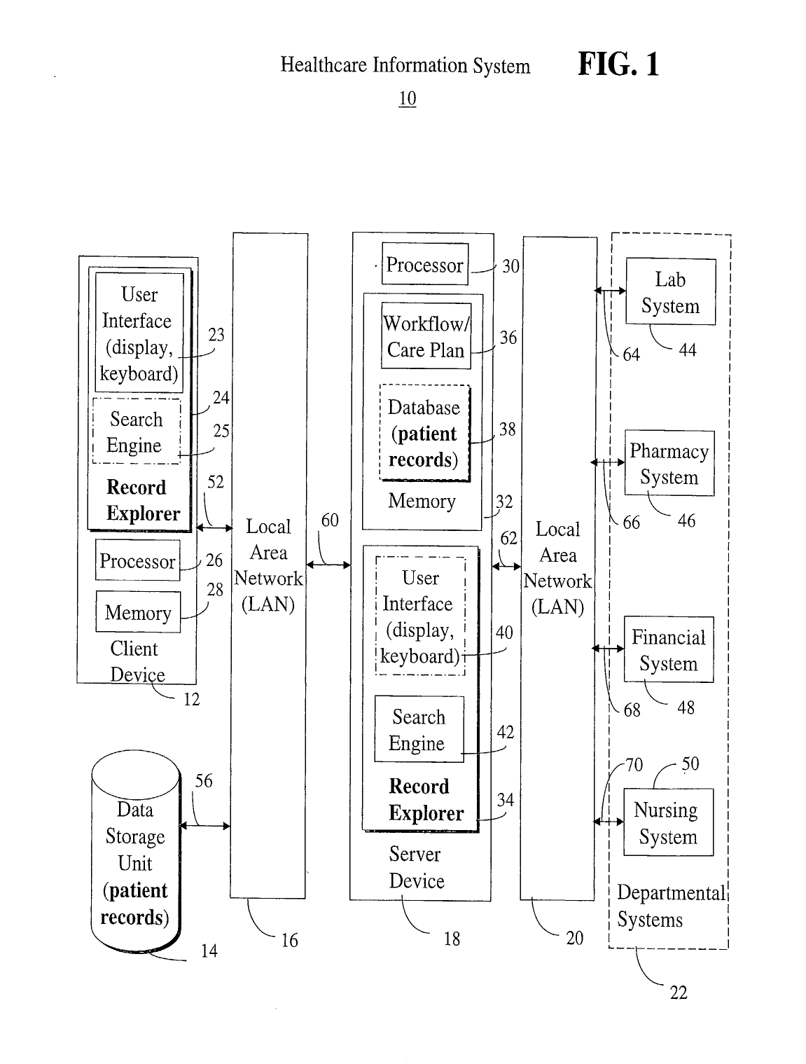

FIG. 1 illustrates a healthcare information system 10 including a record explorer 24 and/or 34, in accordance with a preferred embodiment of the present invention. The healthcare information system 10 generally includes a client device 12, a data storage unit 14, a first local area network (LAN) 16, a server device 18, a second local area network (LAN) 20, and departmental systems 22. The healthcare information system 10 is intended for use by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client.

The client device 12 generally includes a record explorer 24, a processor 26, and a memory unit 28. The record explorer 24 preferably includes a user interface 23 and a search engine 25, but may also include the processor 26 and the memory unit 28. The client device 12 is preferably implemented as a personal computer. The processor 26 and the memory unit 28 constructed and operate in a manner well known to those skilled in the art of the design of client devices.

The user interface 23 in the client device 12 generally includes an input device that permits a user to input information into the client device 12 and an output device that permits a user to receive information from the client device 12. Preferably, the input device is a keyboard, but also may be a touch screen, a microphone with a voice recognition program, for example. Preferably, the output device is a display, but also may be a speaker, for example. The output device provides information to the user responsive to the input device receiving information from the user or responsive to other activity by the client device 12. For example, the display presents information responsive to the user entering information in the client device 12 via the keypad.

The search engine 25 in the client device 12 permits a user to search for specific information among a large amount of information. The search engine 25 is preferably implemented in software, but may also be implemented in hardware. The dashed lines around the search engine 25 represent that the location the search engine 25 in the client device 12 is an alternative location. In the preferred embodiment of the present invention, the search engine 42 is preferably located in the server device 18 to permit multiple users to have access to the same search engine 42 from multiple client devices.

The data storage unit 14 stores patient records, as well as other information for the hospital information system 10. Preferably, the data storage unit 14 is separate from the client device 12 to permit multiple users to have access to the patient records in the data storage unit 14 from multiple client devices. Preferably, the data storage unit 14 is separate from the server device 18 because of the physical size of the memory required to store all of the desired information. The data storage unit 14 may be implemented as read only memory (ROM), such as on a compact disk (CD) or on a hard drive, or a random access memory (RAM), and the like, as is well know to those skilled in the art of data storage units. Alternatively, the patient records may be stored in the database 38 in the memory unit 32 in the server device 18, as shown in dashed lines, in the memory unit 28 in the client device 12, or in memory units in the departmental systems 22, as the memory size becomes physically smaller, has increased capacity and becomes less expensive. An additional consideration would be the advantages and disadvantages of having the patient records stored in a single centralized memory unit or stored in several decentralized memory units among the data storage unit 14, the client device 12, the server device 18 and the departmental systems 22.

Patient records in the data storage unit 14 generally include any information related to a patient including, without limitation, biographical, financial, clinical, workflow, and care plan information. The patient records may be represented in a variety of file formats including, without limitation, text files such as documents, graphic files such as a graphical trace including, for example, an electrocardiogram (EKG) trace, an electrocardiogram (ECG) trace, and an electroencephalogram (EEG) trace, video files such as a still video image or a video image sequence, an audio file such as an audio sound or an audio segment, and a visual file such as a diagnostic image including, for example, a magnetic resonance image (MRI), an x-ray, a positive emission tomography (PET) scan, or a sonogram. The patient record is an organized collection of clinical information concerning one patient's relationship to one major healthcare unit (e.g. region, hospital, clinic, or department). The patient record can narrowly be considered as a file cabinet or repository with divisions and indexing mechanisms. These divisions resemble a hierarchy with folders, documents and document components, or other objects representing collections of clinical elementary information. Such folder divisions include traditional classifications such as summaries, notes, investigations, orders, medications, correspondence, results, etc. Each individual information element and object resides in a home location in this structure. Revision history can be captured from within this home location.

The first local area network (LAN) 16 provides a communication network among the client device 12, the data storage unit 14 and the server device 18. The second local area network (LAN) 20 provides a communication network between the server device 18 and the departmental systems 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, an Internet Protocol (I.P.) data format, a local area network (LAN) protocol, a wide area network (WAN) protocol, an IEEE bus compatible protocol, and a Health Level Seven (HL7) protocol.

The I.P. data format, otherwise called an I.P. protocol, uses IP addresses. Examples of the I.P. addresses include, without limitation, Transmission Control Protocol Internet Protocol (TCPIP) address, an I.P. address, a Universal Resource Locator (URL), and an electronic mail (Email) address. The communication paths 52, 56, 60, 62, 64, 66, 68 and 70 each may be formed as a wired or wireless (W/WL) connection. Preferably, the communication paths 52, 56, 60, 62, 64, 66, 68 and 70 are formed as a wired connection. In the case of a wired connection, the I.P. address is preferably assigned to a physical location of the termination point of the wire, otherwise called a jack. The jack is mounted in a fixed location near the location of the various elements. In the case of a wireless connection, I.P. addresses are preferably assigned to the various elements, since the various elements would be mobile. The wireless connection permits the person using the healthcare information system 10 to be mobile beyond the distance permitted with the wired connection.

The server device 18 generally includes a processor 30, a memory unit 32, and a record explorer 34. The memory unit 32 includes a workflow and/or care plan 36 and a database 38 containing patient records. The record explorer 34 preferably includes a user interface 40 and a search engine 42, but may also include the processor 30 and the memory unit 32. The server device 18 is preferably implemented as a personal computer or a workstation. As mentioned above, the database 38 provides an alternate location for storing the patient records, and the user interface 40 is an alternate interface for the user. Therefore, in the preferred embodiment of the present invention, the record explorer includes the user interface 23 in the client device 12 and the search engine 42 in the server device 18. Alternatively, the record explorer includes both the user interface 23 and the search engine 25 in the client device 12. Still alternatively, the record explorer includes both the user interface 40 and the search engine 42 in the server device 18. Still alternatively, the record explorer includes the user interface 40 in the server device 18 and the search engine 25 in the client device.

The record explorer is the search tool for navigating and locating information in the selected patient's record. The record explorer supports varied and sophisticated methods for searching through the selected patient's record, across all documents and objects related to the patient. The search engine returns the documents and objects that meet the criteria defined by the user. The user can select several items in the results (documents and objects) to move through in a concatenated or filtered view of the items, one after the other. The record explorer is not just a search and view tool. It is one method to reach the place in the patient's record where the user needs to work. The patient information is presented in the context of other associated information within the “filtered” view. For example, if the user needs to work in a document, the user selects the document and the actual document is available for update based on the user's security privileges to the document and its data.

The departmental systems 22 are systems that need access to information or provide information related to the health and/or welfare of people in the care of the healthcare provider. Examples of the departmental systems 22 include, without limitation, a lab system 44, a pharmacy system 46, a financial system 48 and a nursing system 50, as shown in FIG. 1, but may also include a records system, a radiology system, an accounting system, a billing system, and any other system required or desired in a healthcare information system.

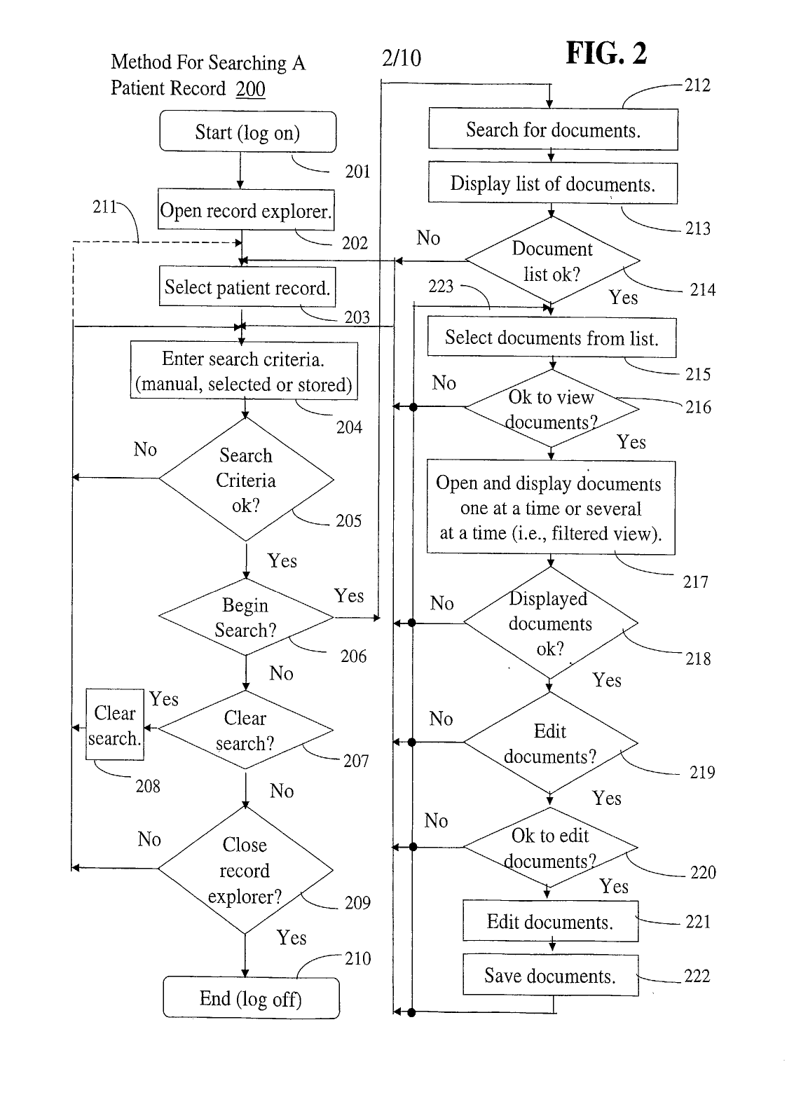

FIG. 2 illustrates a method performed by the record explorer 24 and/or 34, as shown in FIG. 1, for searching a patient record, in accordance with the preferred embodiment of the present invention. As noted above, record explorer 24 and/or 34 includes various combinations of the user interface 23 or 40 and the search engine 25 or 42. Further, as noted above, the patient records may be stored in the data storage unit 14, in the database 38 in the memory unit 32 of the server device 18, in the memory unit 28 of the client device, and/or in memory unit in one or more of the departmental systems 22.

The method 200 includes steps 201-222, not including reference numbers 211 and 223 because they represent alternate flow connections. The steps in FIG. 2 represent either a user decision indicated by an input, such as via the keypad, to the user interface of the record explorer or a response by the record explorer indicated by an output, such as via the display, to the user interface.

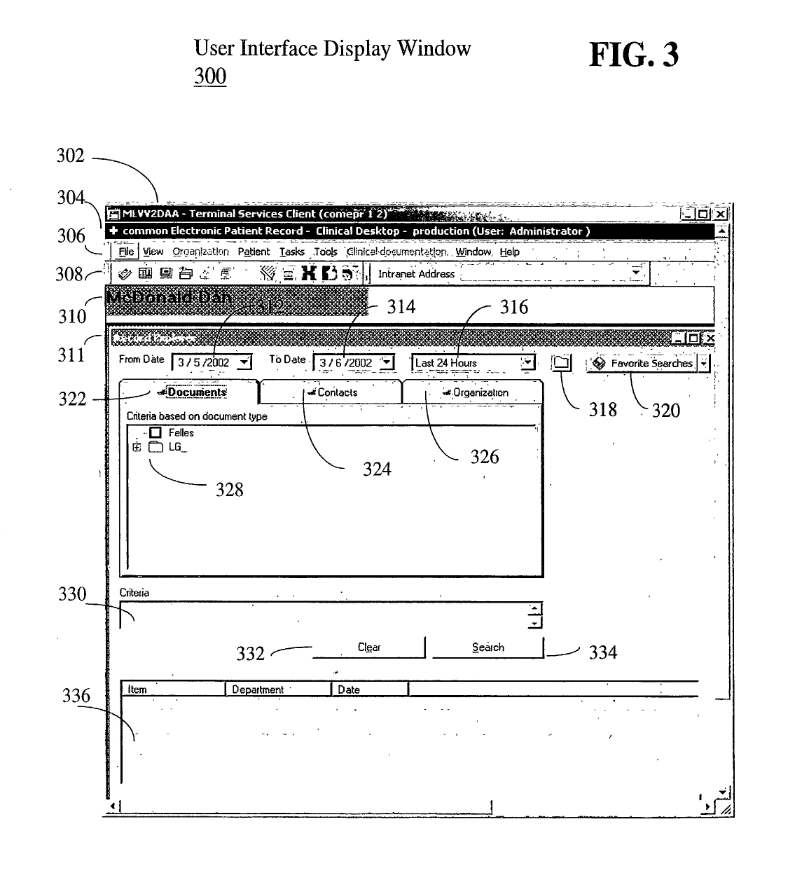

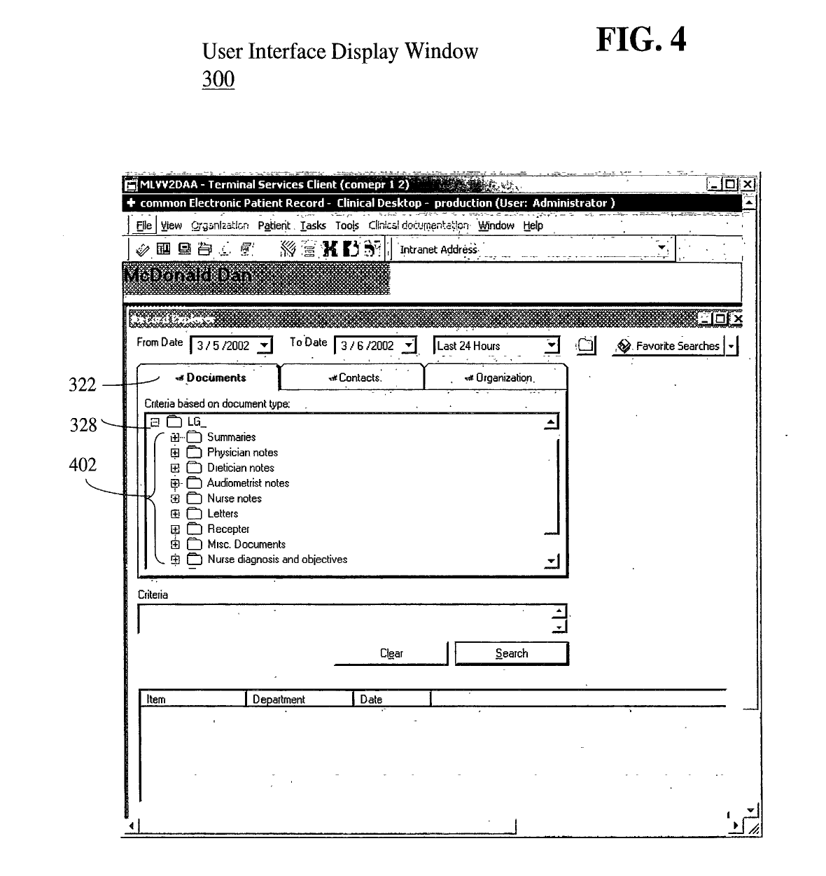

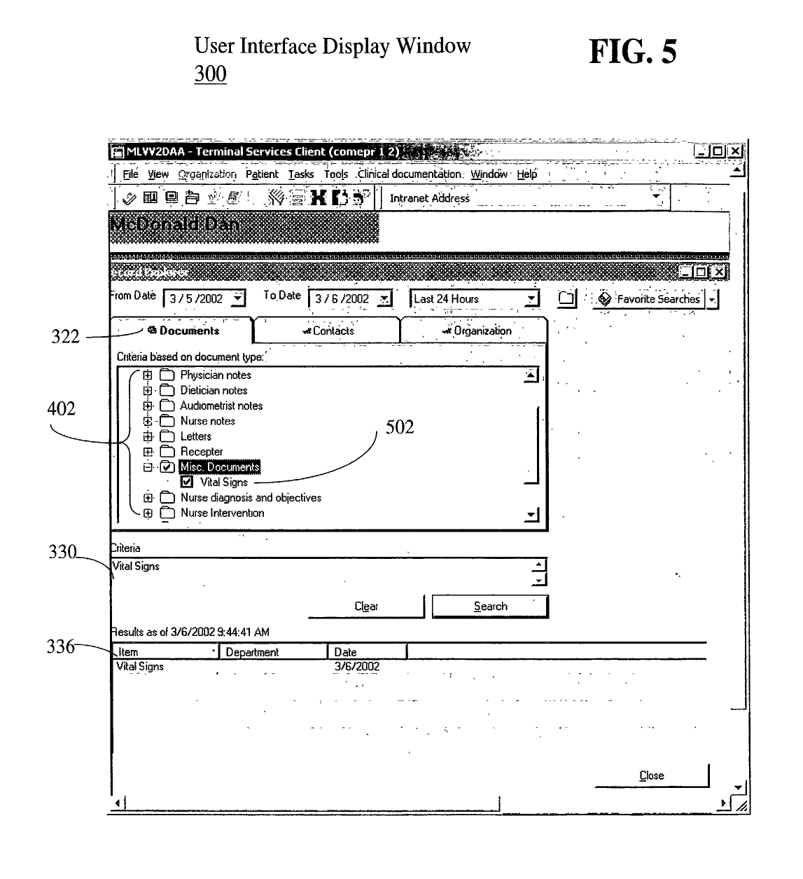

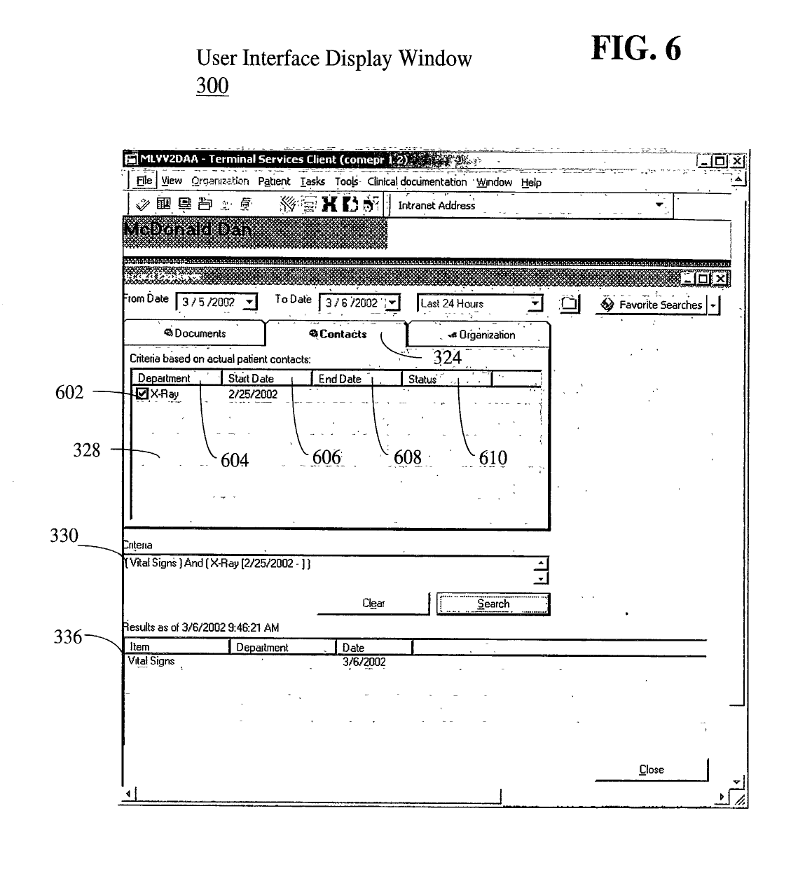

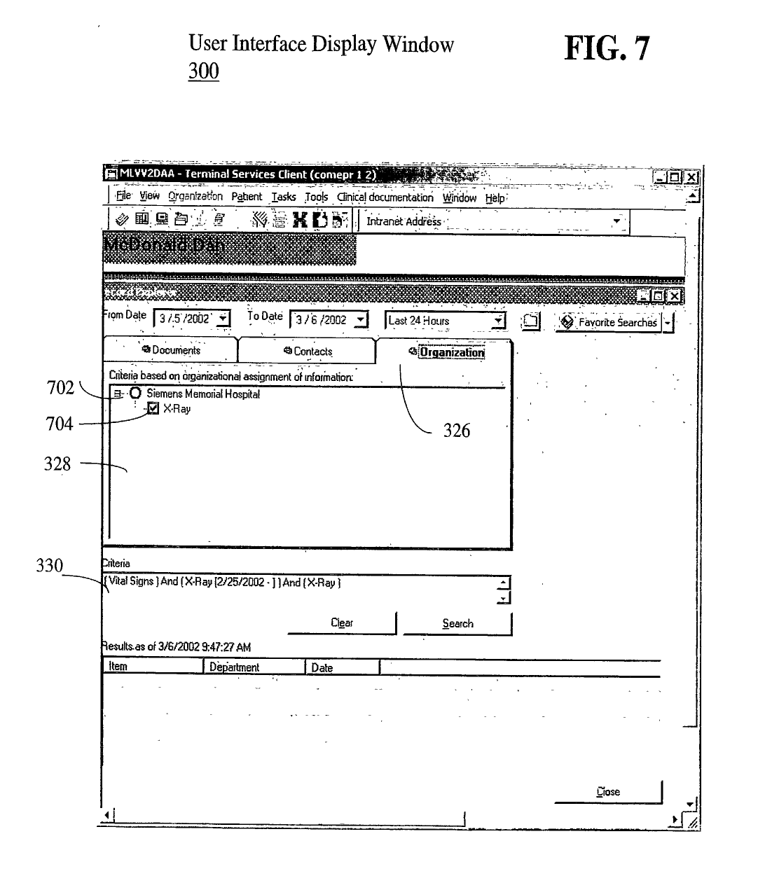

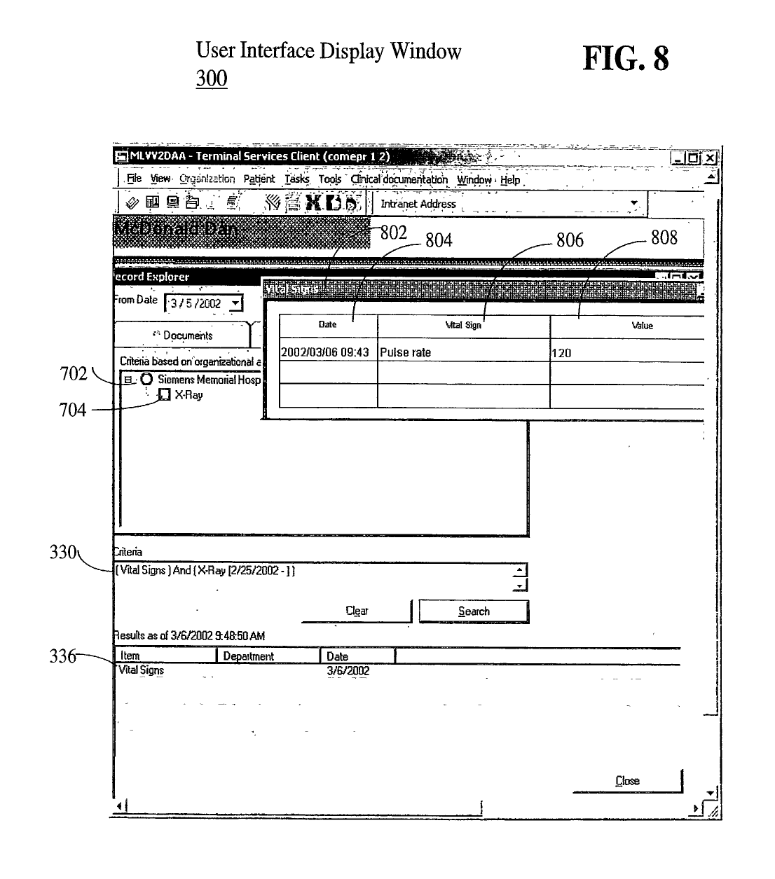

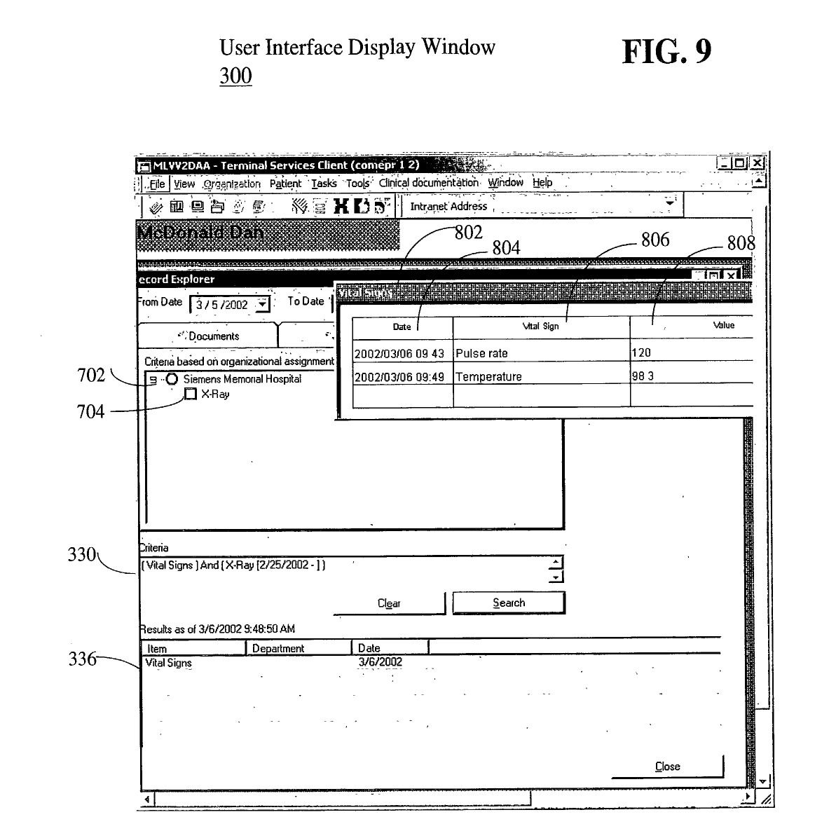

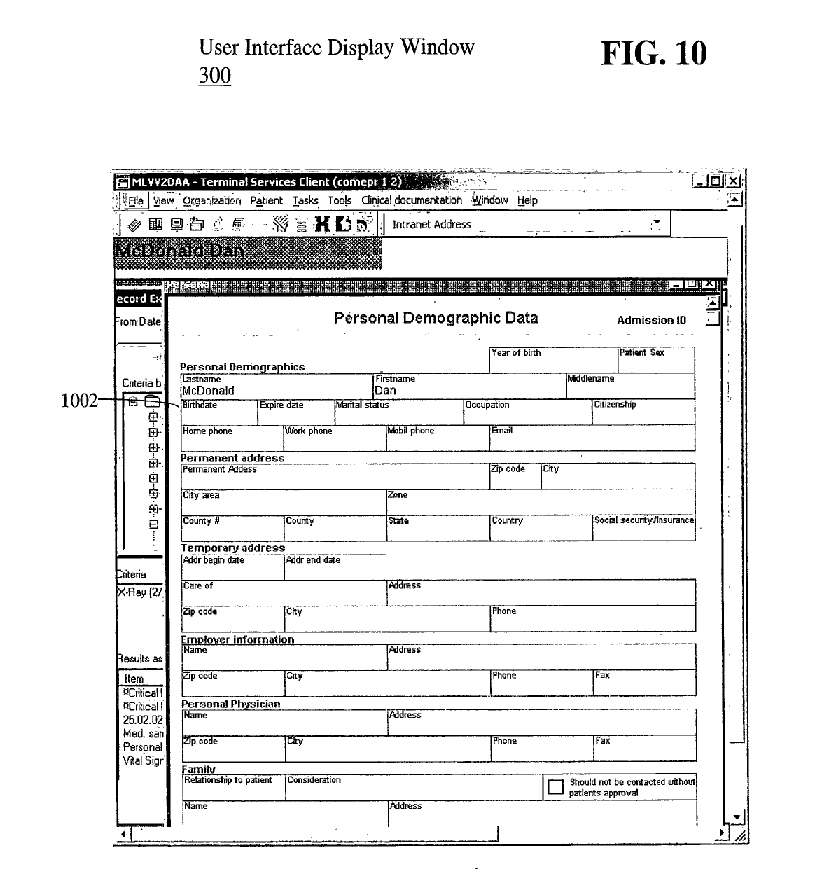

The description for FIG. 2 includes references and detailed descriptions for FIGS. 3-10, which provide examples of various screen shots, otherwise called windows, which the record explorer provides to the display of the user interface. The windows in each of FIGS. 3-10 provides the same general graphic presentation, wherein each window illustrates particular information inputted into or displayed by the record explorer within the common graphic presentation. In FIGS. 3-10, identical features in each window 300 are intended to be the same, but are not repeatedly labeled with the same reference numbers in each figure for the sake of clarity in the figures. In particular, FIG. 3 illustrates the window 300 in the display of the user interface with a documents tab 322 selected for the healthcare information system 10, as shown in FIG. 1, in accordance with the preferred embodiment of the present invention. FIG. 4 illustrates a list of files 402 under the documents tab 322, as shown in FIG. 3, in accordance with the preferred embodiment of the present invention. FIG. 5 illustrates a document 502 selected under one of the files 400, as shown in FIG. 4, in accordance with the preferred embodiment of the present invention. FIG. 6 illustrates the window 300 in the display of the user interface with a contacts tab 324 selected for the healthcare information system 10, as shown in FIG. 1, in accordance with the preferred embodiment of the present invention. FIG. 7 illustrates the window 300 in the display of the user interface with an organization tab 326 selected for the healthcare information system 10, as shown in FIG. 1, in accordance with a preferred embodiment of the present invention. FIG. 8 illustrates a document selected and opened responsive to search criteria selected under the documents tab 322, as shown in FIG. 3, the contacts tab 324, as shown in FIG. 4, and the organization tab 326, as shown in FIG. 7., in accordance with the preferred embodiment of the present invention. FIG. 9 illustrates the document, as shown in FIG. 8, being updated, in accordance with the preferred embodiment of the present invention. FIG. 10 illustrates another example of a document 1002 that may be selected and opened responsive to search criteria selected under the documents tab 322, as shown in FIG. 3, the contacts tab 324, as shown in FIG. 4, and the organization tab 326, as shown in FIG. 7., in accordance with the preferred embodiment of the present invention.

At step 201, the method starts.

At step 202, the record explorer is opened, via an output device of the user interface, responsive to a command received from the user, via the input device of the user interface. Preferably, the record explorer can be opened from any other program running on the hospital information system 10 to permit convenient access to the record when needed. Preferably, the user generates the command by selecting the record explorer from a toolbar or a dropdown menu using a mouse cursor. Alternatively, the user may click a right mouse button when the user's cursor is positioned over the patient header to generate the command.

Preferably, the record explorer opens by displaying the window 300, as shown in FIG. 3. In FIG. 3, the window 300 generally includes a section for displaying header information, a section for defining search criteria, and a second section for displaying the search results. Each of the sections and the individual elements of the sections may be located at any place in the window 300 and should not be limited to the particular located represented in FIGS. 3-10. Further, each of the sections and the individual elements of the sections may be implemented in various similar ways, to achieve the same result, which are well known in the art to those that design user interfaces. For example, the user may enter a command using a manual entry, a drop down window, an icon, a predetermined list, or voice recognition via a microphone, and the like. Further, for example, the information may be presented to the user using a display, having windows, files, text, graphics, images, charts, or lists, and the like, or using voice generation via a speaker.

The header information includes an application field 302, a program field 304, a menu bar 306, a tool bar 308, a patient record field 310, and a record explorer field 311. The application field 302 includes a label (e.g., MLVV2DAA—Terminal Services Client (comEPR 1 2) that identifies the general application running on the client device 12. The program field 304 includes a label (e.g., common Electronic Patient Record—Clinical Desktop—production (User: Administrator) that identifies a particular application running under the general program on the client device 12. The menu bar 306 includes various labels (e.g., File, View, Organization, Patient, Tasks, Tools, Clinical documentation, Window and Help) that permit the user to manipulate the particular program in use. Likewise, the tool bar 308 includes various icons that permit the user to manipulate the particular program in use. The patient record field 310 includes a label (e.g., McDonald Dan) that identifies the patient for a particular patient record. The record explorer field 311 includes a label (e.g., Record Explorer) that identifies the record explorer application running under the general program on the client device 12.

The search criteria represents various categories including a start date field 312, an end date field 314, a recent time duration field 316, a file icon 318, a favorite searches menu 320, a documents tab 322, a contacts tab 324, an organization tab 326, a search criteria display field 330, a clear box 332, and a search box 334.

The start date field 312 provides an area for the user to input or select from a menu of predetermined choices a calendar start date for the patient records to be searched. The end date field 314 provides an area for the user to input or select from a menu of predetermined choices a calendar end date for the patient records to be searched. Alternatively, the date range criteria can be blank and not used by the user. Alternatively, if the end date defaults to a long-term end date, such as Dec. 31, 9999, the start date preferably defaults to the patient birth date. Alternatively, the user may also be permitted to define one or more default time ranges. Preferably, the record explorer alerts the user when the user selects a date range over thirty days for the search and alerts the user if date range or time range is left blank.

The recent time duration field 316 provides an area for the user to input or select from a menu of predetermined choices a recent time duration during which the patient records will be searched. The predetermined choices in the recent time duration field 316 include, for example, the last 24 hours, the last 3 days, the last 7 days, and the last 30 days. Preferably, the recent time duration field 316 defaults to a predetermined choice of the last 24 hours.

The file icon 318 provides the user with access to a selection of searches stored by file name. The favorite searches menu 320 provides the user with access, via a drop down menu, to predetermined stored search criteria that the user frequently uses.

The documents tab 322 causes various files containing document types related to a particular patient record to be displayed in the area 328 for selection by the user as the search criteria, as shown in FIGS. 3-5. In particular, the user selects one or more types of documents to search. In response, the record explorer displays the types of documents defined in a patient record structure in a documentation module. Preferably, the structure includes both public and private clinical documents. An example of a private document is the hard coded orders and results (OaR) documents automatically generated by a documents module at order entry for a referral or for a user-defined activity. The documents module provides desired security checks needed to give the use access to the requested information. Hence when the document category is selected, the system shows a framework, structure or hierarchy of types of documents, even if an individual patient related document does not exist for that document type. The record explorer shows the hierarchy so users can define favorite searches and easily use these searches with another patient. Alternatively, the user may be permitted to view the patient record hierarchy, responsive to a user-defined preference. Examples of types of document include, without limitation: order requisitions, results documents, lab list documents, medication prescriptions, medication administration documents, admission discharge transfer (ADT) patient fact sheet, assessment documents, health care protocol (HCP) notes (i.e., nursing and other types of notes), allergy and other critical information documents, activity documents such as any care plan documents or workflow documents, patient scheduling documents

The contacts tab 324 causes various files containing patent contacts, such as visits, phone calls, emails, etc., related to a particular patient record to be displayed in the area 328 for selection by the user as a search criteria, as shown in FIG. 6. In particular, the user selects one or more contacts to search. The record explorer responds by displaying a list, not a hierarchy, of all registered contacts that the patient has had with the healthcare enterprise. Hence, the contacts tab 324 provides an episodic view of the patient record. The contact information is provided by an ADT module, which also provides desired security checks needed to give the use access to the requested information. The ADT module provides a security validate a user's access to view the contacts. When the contacts tab 324 is selected, the date range is preferably the date(s) of the selected contact(s) causing selected date range in the start date field 312 and the end date field 314 is disabled and shown as grayed out in the window 300. The following information is displayed for each type of contact: name of the contact 604 (e.g., clinic name or type, department name), date of contact 606 (start) and 608 (end), patient status or type 610 (e.g., in patient (IP) or out patient (OP) visit), and diagnosis (if available) (not shown). The display of the patient status 608 and the diagnosis depends on the ADT module's ability to provide this information. The display may require the user to scroll to the right to view all of the information, depending on the size of the display area 328.

The organization tab 326 causes various files containing organizations or departments in the healthcare information system 10 related to a particular patient record to be displayed in the area 328 for selection by the user as the search criteria. In particular, the user selects one or more units for the search. The record explorer responds by displaying the organization hierarchy such as departments, clinics, or units at the institution or in the region. The ADT module provides the organization hierarchy and provides desired security checks needed to give the user access to the requested information. The name of organization is displayed for each type of organization. The organization search criteria and the contact search criteria can be combined, for example, to give the user a list of surgical consultant notes created while the patient was at the medical department.

In FIG. 3, the search criteria display field 330 is an area in the window 300 that displays all of the search criteria entered in or selected from a menu of predetermined choices by the user. The search criteria displayed in the search criteria display field 330 includes at least one of the start date field 312, the end date field 314, the recent time duration field 316, the file icon 318, the favorite searches menu 320, the documents tab 322, the contacts tab 324, and the organization tab 326.

The clear box 332 permits the user to clear the present search criteria responsive to a single mouse click on the clear box 332. Hence, the clear box 332 provides a convenient way for the user to delete the present search criteria to start new search criteria.

The search box 334 permits the user to start the search engine searching for the desired patent records responsive to the search criteria entered by the user. Hence, the search box 334 notifies the record explorer that the user has completed the search criteria and desires to receive the search results.

Other categories, not shown in the figures, that may be included as an alternative or in addition to the previous categories mentioned above, include an activity tab and a contents tab. The activities tab causes various files containing activities related to a particular patient record to be displayed for selection by the user as the search criteria. In particular, the user selects one or more activity items such as, for example, problems, care plans, and other activities for the search criteria. The record explorer responds by displaying a list of all the problems, care plans, and other activities associated with the patient. Activity items are defined in an activity-handling module. The activity-handling module provides desired security checks needed to give the use access to the requested information.

The types of problems listed under the activity tab include active, inactive, and invalid. When the active type is selected, the result pane displays the list of problems, including the problem name and the start date. When the inactive type is selected, the result pane displays the list of problems, including the problem name, the start date and the end date. When the invalid type is selected, the result pane displays the list of problems, including the problem name, the start date and the end date.

The types of care plans listed under the activity tab include active/in progress, complete, cancelled, and inactive. When the active/in progress type is selected, the result pane displays in a list the names of active care plans, the status, and the start date. The list is sorted by start date, with the most recent listed first. Selecting a care plan will launch an activity planner with a focus on the care plan selected. When the complete type is selected, the result pane displays the names of care plans, the status, the start date, and the completion dates. When the cancelled type is selected, the result pane displays the names of care plans, the status, the start date, and the date of cancellation. When the inactive type is selected, the result pane displays the names of care plans, the status, and the start date. When the invalid type is selected, the result pane displays the names of care plans, the status, the start date, and the date of deletion

The activities tab also includes types of service classification subfolders such as active/scheduled/in progress, inactive/suspended, complete, and cancelled/invalid. When the active/scheduled/in progress subfolder is selected, the result pane displays the name of activities, the status, and the start date. Preferably, these activities are sorted according to status in order from active, to scheduled, to in progress. This secondary sort is on start date with the most recent one listed first. Selecting the activity displays the corresponding outcome information. When the inactive/suspended subfolder is selected, the result pane displays the name of activities, the status, the start date, and the inactive/suspend date. Preferably, these activities are sorted according to status in order from inactive to suspend. This secondary sort is on inactive/suspend date with the most recent one listed first. When the complete subfolder is selected, the result pane displays the name of the activities, the status, the start date, and the complete date. Preferably, these activities are sorted by the completion date with the most recent one listed first. When the cancelled/invalid subfolder is selected, the result pane would display the name of activities, the status, the start date, and the cancellation/deletion date. Preferably, these activities are sorted according to status in order from cancelled to inactive. This secondary sort is on cancellation/deletion date with the most recent one listed first.

The contents tab causes various files containing clinical terms related to a particular patient record to be displayed for selection by the user as the search criteria. In particular, the user selects one or more terms for the search. The record explorer responds by displaying a list of all the elements in the clinical documentation element dictionary and the healthcare foundation class (HFC) object list, which is similar to the list displayed in a statistics and research (SaR) module. Keywords may provide synonym search and may represent larger groupings of keywords that may represent broader clinical terminology. Free text searches on text are not associated with known keywords. Free text search preferably returns the values saved within an element, such as a phrase used consistently within the results text.

Returning to FIG. 2, at step 203, a patient record is selected responsive to a command received from the user, via the input device of the user interface. The patient record may be selected by inputting any information including, without limitation, a patient's name, social security number, bed number, chart number, address, and the like. Step 203 preferably is performed after step 202, but may alternatively be performed before step 202, responsive to the user's decision. If the user selects a new patient record, the record explorer clears the results area 336 and all search criteria. Preferably, when the user selects a new patient record, the record explorer effectively closes and reopens to refresh the record explorer.

At step 204, the user enters the search criteria selected from among the various categories and types under the categories described above. The user selects specific items from the displayed list shown in area 328. The record explorer visually marks the items selected to provide feedback to the user. The user may repeat the category selection for all of the desired categories. The record explorer displays the additional selected categories and the underlying detail for the selected search category. For example, the user may select visits, units, or other types of documents among the various category tabs, as described above. The user is permitted to select one or more documents types among several categories of patient information to provide focused search criteria for the search. For example, user selects the document category of “nursing notes” and one or more specific visits, at specific organizations (e.g., clinics) of the enterprise. The user is provided with a summary of the search criteria in the search criteria display field 330. The search criteria display field 330 is updated after every selection to display all of the items that the user has currently selected. If user deselects an item, the record explorer also updates the search criteria display field 330 to reflect the fact that the item was deleted from the search criteria. Hence, the search criteria display field 330 represents the current state of the search criteria selected by the user.

In a more extensive example, as shown in FIG. 3, the user enter the start date, the end date, the recent time duration, selects the document tab 322 to display a list of files (e.g., “LG”) or document types in the area 328. Next, as shown in FIG. 4, the user opens (i.e., expands) the “LG” file in the area 328 to view additional a list of files 402 contained in the “LG” file. Next, as shown in FIG. 5, the user selects the “vital signs” document type under the “Misc. documents” file by moving the mouse cursor over the box next to the document type and clicking on the mouse button. Note that the document type labeled “vital signs” appears in the search criteria display field 330 to indicate to the user that the document type was selected. Next, the user selects the contacts tab 324 to display a list of files or document types (e.g., “X-ray”) in the area 328. The area 328 associated with the contacts tab 324 includes field headers for a department 604, a start date 606 (e.g., listed as (Feb. 25, 2002”), an end date 608, and a status 610. Note that the document type labeled “vital signs” and the documents type “X-ray” including a date associated with the X-ray appears in the search criteria display field 330 to indicate to the user that the cumulative search criteria selected by the user. Next, as shown in FIG. 7, the user selects the organization tab 326 to display a list of organizations 702 (e.g. “Siemens Memorial Hospital”) or document types 704 (e.g., “X-ray”) in the area 328. Note that the document type labeled “vital signs,” the documents type “X-ray” including a date associated with the X-ray, and the document type “X-ray” associated with the particular organization appears in the search criteria display field 330 to indicate to the user that the cumulative search criteria selected by the user. In another example, not shown, the user selects the document category “note” under the documents tab 322 and the system displays the subcategories “nursing notes” and other notes categories. Hence, the system displays the selected category for the search criteria and the underlying hierarchical detail (i.e., subsets and individual items) for the selected category for the search criteria.

After entering the search criteria, the user may want to save the search criteria for future use, without having to create the entire search over again for the same or different patient. The search criterion may be saved under the folder icon 318 or under the “favorite searches” drop down menu. If the user saves the search criteria without specifying a date or time range, the record explorer save a default date/time range, such as the last 24 hours. Under the folder icon 318, the record explorer displays a tree structure of saved searches and the associated folders in which the user collects and saves searches. The user is permitted to organize searches in the folders for ease of retrieval for a search. The record explorer displays the favorite search folder structure. The user is permitted to add a new folder, modify a folder name, delete a folder, and save a search to a specific folder. The record explorer uses the highest folder in the tree structure, as a default location. The record explorer prompts the user for a name for the saved query. The record explorer also prompts the user to name the folder in which to save the search criteria. The record explorer warns the user if the name of the saved query or the name of the folder is the same as another saved search or folder. Once the search criteria has been created and stored, the user can select a saved search from the folder or subfolder under the folder icon 318. When the user selects a favorite saved search, the record explorer retrieves and displays the selected search criteria in the search criteria field 330 and displays appropriate checks within the tabs on the screen and enters the appropriate dates and times in the corresponding fields. Preferably, the title bar displays the name of the saved search. If any search criteria, such as under one of the tabs, has changed since the search criteria was saved, the record explorer displays an error message and explains that the search criteria has changed. The user may add to or modify the search criteria of the saved search.

At step 205, the record explorer determines if the search criteria is ok, as displayed in the search criteria field 330. If the user approves of the search criteria, then the method continues to step 206. Otherwise, if the user does not approve of the search criteria, then the method returns to step 203, wherein the user may select another patient record, or to step 204, wherein the user may enter or modify the search criteria.

At step 206, the record explorer determines if the user initiated a search responsive to the search criteria being ok, at step 205. The search engine determines that the user wants to initiate a search by the user selecting the search box 334. If the user does not select the search box 334, then the method continues to step 207; otherwise the method continues to step 212.

At step 207, the record explorer determines if the user wants to clear search criteria indicating that the user wants to create a new search from scratch. If the record explorer determines that the user wants to clear the search criteria, then the method continues to step 208. Otherwise, the method continues to step 209.

At step 208, the record explorer clears the search responsive to the user selecting the clear box 332. The record explorer clears the results pane and clears all selected search criteria. Then, the method continues to 203, wherein the user may select another patient record, or to step 204, wherein the user may enter or modify the search criteria.

At step 209, the record explorer determines if the user wants to close the record explorer program. Preferably, the record explorer is kept in the background on the desktop of the client device 12 selects a new patient or selects another general program (e.g., comEPR function), until closed by the user or called by the user. If the record explorer determines that the user does not want to close the record explorer, the method returns to step 203, wherein the user may select another patient record, or to step 204, wherein the user may enter or modify the search criteria; otherwise, the method continues to step 210.

At step 210, the method ends by closing the record explorer application.

Continuing with step 212, the record explorer searches for documents responsive to the search criteria that the user entered.

At step 213, the record explorer displays a list of documents responsive to the search performed by the search engine. The search results are displayed in the area 336 responsive to the output from the search engine to permit the user to review the search results. The record explorer displays the item title, the department and the date of the document. Preferably, the user may sort the search results by the user according to the headings of the displayed columns (i.e., department, document, date). The record explorer may also display the healthcare foundation class (HFC) objects, which match the selected criteria. The record explorer may also display a matrix for numerical data, such as lab results, or an extract of text sequences (e.g., templates and elements or element sets) rather than complete documents. Preferably, the module, outside of the record explorer, that contains the document to be searched controls the user access to the document. Preferably, the system displays a time stamp of the search results so users know the age of the results returned from the search. If the user needs the most current results or if the user changes search criteria, the user must refresh the search results by pressing the search box 334 again.

At step 214, the user determines if the displayed list of documents is ok. If the user thinks that the displayed list of documents is ok, then the method continues to step 215; otherwise, the method returns to step 203, wherein the user may select another patient record, or to step 204, wherein the user may enter or modify the search criteria. Note that a list of documents is not specifically shown in the figures.

At step 215, the user selects documents from the displayed list. Preferably, the user makes the selection by checking a box next to the desired documents or objects. Note that the selection of documents is not specifically shown in the figures.

At step 216, the record explorer determines if the user is authorized to view the selected documents. If the record explorer authorizes the user to view the selected documents, then the method continues to step 217. Otherwise, the method returns to step 203, wherein the user may select another patient record, to step 204, wherein the user may enter or modify the search criteria, or to step 215, wherein the user may select other documents from the list. In practice, the record explorer calls the module that stores or owns the selected item(s) and passes the user's security information to that module. The called module checks security on the document or object and the user's viewing privileges. If the user doesn't have access to a document in the result set and the user has the right to invoke emergency access, the record explorer prompts the user with an emergency access screen. If the user invokes emergency access, the record explorer displays all documents for viewing by the user. If the user selects not to invoke emergency access, the record explorer displays only the documents that the user has the right to view. Hence, module called by the record explorer handles the access to read and/or write to a document. Preferably, if there is a limit to the number of documents the user may open, the record explorer warns that too many documents are opened at one time.

At step 217, the record explorer opens and displays the documents one at a time or several at a time (i.e., a filtered view). An example of an opened document is shown in FIG. 8, as document 802, and in FIG. 10, as document 1002. In the filtered view (not shown in the figures), the record explorer displays in one view the selected documents and objects in date/time order according to a user preference as to descending or ascending order. In the filtered view the documents are concatenated or stepped one in front or behind the others with the title bar showing for each document window. Additional sorts may be by date, department, or type of document. Preferably, the display shows a watermark that indicates the user is in a view, not in the actual document (a Norwegian requirement). If the results of the search are mixed documents and objects, the record explorer preferably displays documents together and the healthcare foundation class (HFC) objects together, without mixing them in display view. However, if the view is mixed between documents and HFC objects, the record explorer may provide a list of hits and let user browse in and out of the viewable documents. However, this list view does not meet the requirements in Scandinavia. Preferably, the record explorer automatically marks (i.e., bookmarks) those documents that the user has viewed whether the view was within a filtered view or from selecting and moving among documents.

At step 218, the user determines if the displayed documents are ok. If the record explorer determines that the displayed documents are ok for the user, then the method continues to step 219. Otherwise, the method returns to step 203, wherein the user may select another patient record, to step 204, wherein the user may enter or modify the search criteria, or to step 215, wherein the user may select other documents from the list. In practice, the user pages up, down, or through the views of all the displayed documents. The record explorer displays any formatting and colors used in any documents included in the search results. Preferably, the filtered view does not display ASCII data. Preferably, the user may search for keywords or phrases within the filtered view or a single document view. Preferably, when the record explorer displays a content search in the filtered view mode, the user cannot edit the document since the content search only shows pieces of documents.

At step 219, the record explorer determines if the user wants to edit the displayed documents responsive to a command from the user. If the record explorer determines that the user wants to edit the documents, then the method continues to step 220. Otherwise, the method returns to step 203, wherein the user may select another patient record, to step 204, wherein the user may enter or modify the search criteria, or to step 215, wherein the user may select other documents from the list. In practice, the user indicates a desire to edit a document, such as by selecting an edit box (not shown), by selecting an edit function from a pull down menu, or an edit icon.

At step 220, the record explorer determines if the user is authorized to edit the displayed documents. If the record explorer determines that the user is authorized to edit the displayed documents, then the method continues to step 221. Otherwise, the method returns to step 203, wherein the user may select another patient record, to step 204, wherein the user may enter or modify the search criteria, or to step 215, wherein the user may select other documents from the list. In practice, the called module allows editing based on the user's access. The called module checks the user's security access on the document and the user's privilege to update data the document. With appropriate access, the user may edit/update/quit from the document. The update ability is based on user privileges for this document type and information access (i.e., security). The user may update a selected document within the filtered view based on the user's privileges to update the selected document.

At step 221, the user edits the documents. An example of a document being edited is shown as document 802 in FIG. 9. In practice, the user moves through the fields/objects and edits the document, as desired. The called module allows the user to move through the document or objects. Preferably, if the user is in the filtered view, the filtered view is temporarily suspended when the user indicates a desire to update the document.

At step 222, the user saves the edited documents. The user indicates completion of an edit based on the called module method. For example, the user closes and simultaneously saves the document or object the user is working on. The called module updates the database. The called module keeps an audit of all the documents/objects, which the user has viewed and/or updated. The record explorer may create a bookmark in the view to indicate the user's place and items reviewed. If the user was in a filtered view document, the record explorer displays the filtered view again with the updated information. The record explorer may track the view when record explorer is in the filtered view. Then, the user may select another document listed in the results area 336 and view or update that document(s). The record explorer allows the user to easily move back and forth among the selected documents and objects within the patient record. The user can have multiple documents open at one time.

In brief summary of the preferred embodiment of the present invention, the record explorer includes a search engine and a user interface that enables users to define search criteria in order to search across clinical documents and data objects associated with a patient. The record explorer returns a list of documents and objects that are the results of the search. The user with appropriate entitlements selects the needed documents or objects to view information. Additional features include the ability to search for data related to clinically relevant keywords and concepts. Users with expanded entitlements may edit the appropriate data. An additional feature is the filtered view which allows a user to select several relevant documents causing the record explorer to display all the documents and/or objects in one view, one after the other so the user can page through the documents without opening and closing each one.

The record explorer allows users to define their desired search criteria easily by allowing users to make selections from lists and to enter data into search field to combine categories of search criteria, or select from their favorite or stored searches. Then, the users move to the exact document or object to view or update the document or object. The Content tab provides text based or keyword based search for specific search focus. The filtered view provides an easy to use tool that combines selected documents so users quickly review and then reach the areas where updates are needed, for example in viewing and then updating progress notes.

Hence, while the present invention has been described with reference to various illustrative embodiments thereof, the present invention is not intended that the invention be limited to these specific embodiments. For example, the architectures, windows and processes presented in FIGS. 1-10 are not exclusive. Other architectures, windows and processes may also be derived in accordance with the principles of the invention to accomplish the same objectives. Further, the inventive principles may be advantageously employed in any record explorer system and is not limited to use in the healthcare field. Those skilled in the art will recognize that variations, modifications and combinations of the disclosed subject matter can be made without departing from the spirit and scope of the invention as set forth in the appended claims.

What is claimed is:

1. A method for searching a patient record, comprising the steps of:
receiving user identification information;
receiving first search criteria including at least one of,
information for use in identifying a particular document,
information for use in identifying a particular patient visit, and
information for use in identifying a particular organization;
receiving second search criteria identifying at least one category of said first search criteria; and
initiating a search of the patient record in response to said received first and second search criteria.

2. A method according to claim 1, further comprising the steps of:
receiving search results comprising information identifying documents with characteristics matching said first and second search criteria;
validating that said user is authorized to access said identified documents; and
inhibiting display of information identifying said documents in response to a determination said user is unauthorized to access said identified documents.

3. A method according to claim 2, wherein
said step of validating employs said received user identification information.

4. A method according to claim 1, wherein
said identified documents comprise a multimedia file including at least one of, (a) a still video image, (b) a video image sequence, (c) an audio segment, (d) a patient diagnostic image and (e) a graphical trace.

5. A method according to claim 4, wherein
said patient diagnostic image comprises at least one of (i) an MRI scan, (ii) an x-ray, (iii) a PET scan, (iv) a sonogram and
said graphical trace comprises at least one of (I) an EKG trace, (II) an ECG trace, and (III) an EEG trace.

5. A method according to claim 1, wherein
said first search criteria includes user-entered text.

6. A method according to claim 5, wherein
said user entered text includes text comprising at least one of, (a) a medical procedure identification code, (b) a medical condition identification code, (c) a medical term, (d) care plan identification information and (e) medical condition identification information.

7. A method for providing a user interface for use in searching a patient record, comprising the steps of:
receiving user identification information;
initiating generation of at least one display image supporting, user selection of first search criteria including at least one of,
information for use in identifying a particular document,
information for use in identifying a particular patient visit, and
information for use in identifying a particular organization, and supporting user selection of second search criteria identifying at least one category of said first search criteria; and
initiating a search of the patient record based on said received first and second search criteria in response to user command via said at least one display image.

8. A method according to claim 7, wherein
said at least one display image comprises a composite window representing a plurality of overlaid tabbed windows each including a visible tab incorporating an identifier identifying individual criteria of said first search criteria.

9. A method according to claim 8, wherein
said composite window displays a tabbed window in the foreground of said composite window in response to user selection of a visible tab corresponding to one of said first search criteria and said foreground tabbed window displays second search criteria identifying a plurality of categories of said selected one of said first search criteria.

10. A method according to claim 7, wherein
said first search criteria includes user-entered text.

11. A method according to claim 10, wherein
said user entered text includes text comprising at least one of, (a) a medical procedure identification code, (b) a medical condition identification code, (c) a medical term, (d) care plan identification information and (e) medical condition identification information.

12. A record explorer for a healthcare information system comprising:
a user interface including:
an input device adapted to receive search criteria related to a patient record; and
an output device adapted to provide search results responsive to receiving the search criteria; and
a search engine adapted to perform a search responsive to receiving the search criteria to generate search results.

13. A record explorer according to claim 12 wherein the search criteria further comprises at least one of:
a date range category;
a recent time duration category;
a documents category;
a contacts category;
an organizations category;
an activities category; and
a contents category.

14. A record explorer according to claim 13 wherein at least one of the documents category, the contacts category, the organizations category, and the activities category further comprises:
a list of types of documents;
a list of types of contacts;
a list of types of organizations; and
a list of types of activities, respectively.

15. A record explorer according to claim 12 wherein the search criteria are entered into a display window.

16. A record explorer according to claim 12 wherein the user interface is associated with a client device and the search engine is associated with a server device.

17. A record explorer according to claim 12 wherein the output device further comprises:
a display, wherein the search results are displayed in a filtered view.

18. A record explorer for a healthcare information system comprising:
a user interface, associated with a client device, including:
an input device adapted to receive search criteria related to a patient record, wherein the search criteria further comprises at least one category and at least one selection under the at least one category; and
an output device adapted to provide search results responsive to receiving the search criteria, wherein the output device comprises a display window adapted to display the search criteria received by the input device and adapted to display the search results; and
a search engine, associated with a server device, adapted to perform a search responsive to receiving the search criteria to generate the search results.

19. A record explorer according to claim 18 wherein the at least one category further comprises at least one of:
a date range category;
a recent time duration category;
a documents category;
a contacts category;
an organizations category;
an activities category; and
a contents category.

20. A record explorer according to claim 19 wherein at least one of the documents category, the contacts category, the organizations category, and the activities category further comprises:
a list of types of documents;
a list of types of contacts;
a list of types of organizations; and
a list of types of activities, respectively.
